(19) United States
(12) Patent Application Publication
(10) Pub. No.: US 2007/0156550 A1
(43) Pub. Date: Jul. 5, 2007

(54) Architectural design for cash and liquidity management application software

(76) Inventors: Martin Von Der Emde, Wiesloch (DE); Thomas Hoffmann, Roemerberg (DE); Stefan Kaetker, Dossenheim (DE); Jens Freund, Heidelberg (DE); Gerd Moosmann, Pforzheim (DE); Peter Latocha, Malsch (DE)

Correspondence Address: FISH & RICHARDSON, P.C., PO BOX 1022, MINNEAPOLIS, MN, 55440-1022, US

(21) Appl. No.: 11/322,772

(22) Filed: Dec. 30, 2005

(51) Int. Cl. G06Q 40/00

(52) U.S. Cl. 705/35

(57) ABSTRACT

Methods, systems, and apparatus, including computer program products, for implementing a software architecture design for a software application implementing cash and liquidity management useful to assure that an organization has sufficient liquidity to fulfill all outstanding debits in time. The application is structured as multiple process components interacting with each other through service interfaces, and multiple service interface operations, each being implemented for a respective process component. The process components include a Accounting process component, a Due Item Management process component, a Payment Processing process component, and a Cash Management process component.

### BACKGROUND

The subject matter of this patent application relates to computer software architecture, and more particularly to the architecture of application software for cash and liquidity management.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

### SUMMARY

This specification presents a software architecture design for a software application.

The invention can be implemented as methods, systems, and apparatus, including computer program products, for implementing a software architecture design for a software application implementing cash and liquidity management useful to assure that an organization has sufficient liquidity to fulfill all outstanding debits in time. The application is structured as multiple process components interacting with each other through service interfaces, and multiple service interface operations, each being implemented for a respective process component. The process components include a Accounting process component, a Due Item Management process component, a Payment Processing process component, and a Cash Management process component.

The invention can further be implemented as methods, systems, and apparatus, including computer program products, implementing a software architecture design for a software application that is adapted to interact with external software systems through the service operations described in reference to external process components, or a subcombination of them.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIG. 1 is a block diagram of a software architectural design for a cash and liquidity management software application.

FIG. 2 illustrates the elements of the architecture as they are drawn in the figures of this patent application.

FIG. 3 is a block diagram showing interactions between a Further Cash Management process component and a Cash Management process component.

FIG. 4 is a block diagram showing interactions between a Cash Management process component and a Due Item Processing process component.

FIG. 5 is a block diagram showing interactions between a Payment Processing process component and a Settlement Processing at Clearing House process component.

FIG. 6 is a block diagram showing interactions between a Due Item Processing process component and an Accounting process component.

FIG. 7 is a block diagram showing interactions between a Payment Processing process component and a Payment order processing at house bank process component.

FIG. 8 is a block diagram showing interactions between a Payment Processing process component and an Accounting process component.

FIG. 9 is a block diagram showing interactions between a Payment Processing process component and a Due Item Processing process component.

FIG. 10 is a block diagram showing interactions between a LockBox File creation at provider process component and a Payment Processing process component.

FIG. 11 is a block diagram showing interactions between a Bank statement creation at bank process component and a Payment Processing process component.

Like reference numbers and designations in the various drawings indicate like elements.

### DETAILED DESCRIPTION

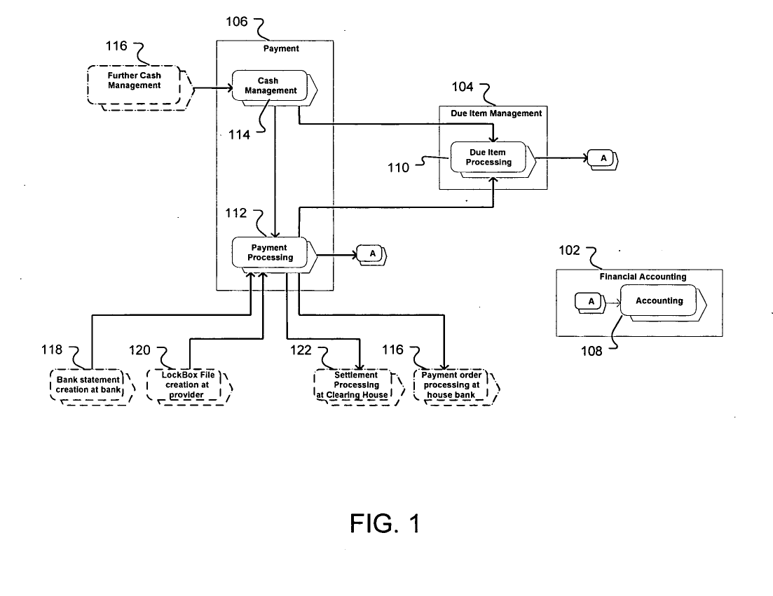

FIG. 1 shows the software architectural design for a cash and liquidity management software application. The cash and liquidity management application is software that implements an end-to-end process used to assure that the company has sufficient liquidity to fulfill all outstanding debits in time.

The cash and liquidity management design includes three deployment units: a Financial Accounting deployment unit 102, a Due Item Management deployment unit 104, and a Payment deployment unit 106.

The Financial Accounting deployment unit 102 contains an Accounting process component 108 that records all relevant business transactions.

The Due Item Management deployment unit 104 includes a Due Item Management process component 110. The Due Item Management process component 110 is used to manage all payables and receivables from service and supply and corresponding sales including a withholding tax.

The Payment deployment unit 106 includes a Payment Processing process component 112 and a Cash Management process component 114. The Payment Processing process component 112 is used to handle all incoming and outgoing payments as well as to represent the main database for a liquidity status. The Cash Management process component 114 is used to analyze and the management of the actual and future flow of money.

A number of external process components, described below, will be used to describe the architectural design. These include a Further Cash Management process component 116, a Bank statement creation at bank process component 118, a LockBox File creation at provider process component 120, a Settlement Processing at Clearing House process component 122, and a Payment order processing at house bank process component 124.

The Further Cash Management process component 116 may provide information for the Cash Management process component 114.

The Bank statement creation at bank process component 118, the LockBox File creation at provider process component 120, the Settlement Processing at Clearing House process component 122, and the Payment order processing at house bank process component 124 may interact with the Payment Processing process component 112. The Payment Processing Process component 112 also receives messages from the Bank statement creation at bank process component 118. The message may include a bank statement for a bank account. The LockBox File creation at provider process component 120 may update a business object in the Payment Processing process component 112. The Settlement Processing at Clearing House process component 122 and the Payment order processing at house bank process component 124 may receive updates from business objects in the Payment Processing process component 112.

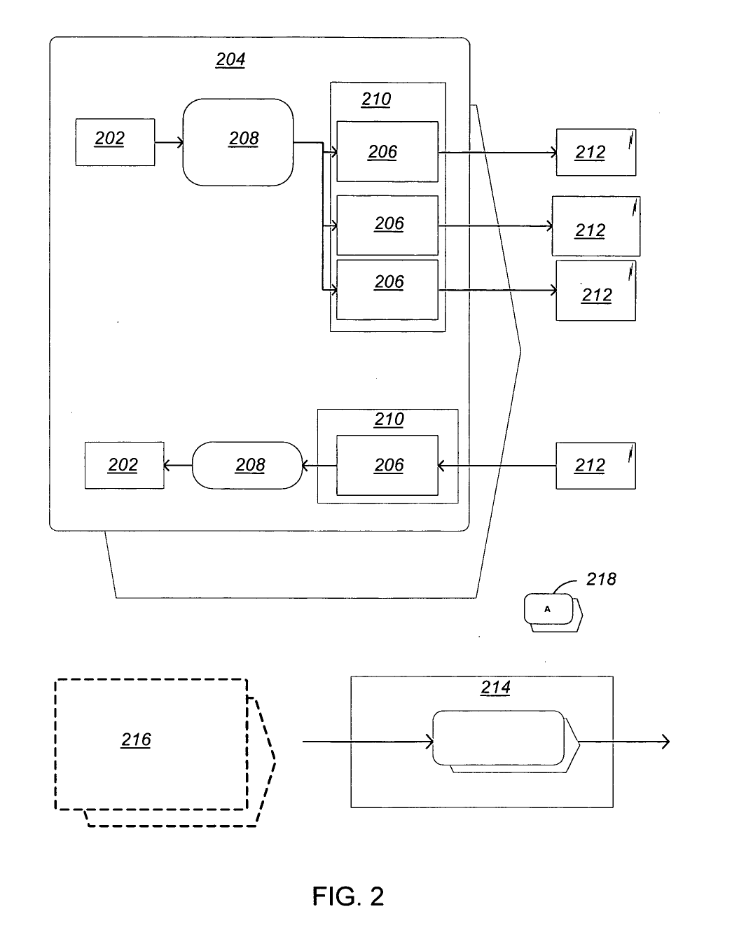

FIG. 2 illustrates the elements of the architecture as they are drawn in the figures of this patent application. The elements of the architecture include the business object (drawn as icon 202), the process component (drawn as icon 204), the operation (drawn as icon 206), the process agent (drawn as icon 208), the service interface or interface (drawn as icon 210), the message (drawn as icon 212), and the deployment unit (drawn as icon 214).

Not explicitly represented in the figures is a foundation layer that contains all fundamental entities that are used in multiple deployment units. These entities can be process components, business objects and reuse service components. A reuse service component is a piece of software that is reused in different transactions. A reuse service component is used by its defined interfaces, which can be, e.g., local APIs (Application Programming Interfaces) or service interfaces.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are assigned to their respective deployment unit.

A process component of an external system is drawn as a dashed-line process component (drawn as icon 216). Such a process component may be referred to as an external process component, and it is used to represent the external system in describing interactions with the external system; however, this should be understood to require no more of the external system that it be able to produce and receive messages as required by the process component that interacts with the external system.

The connector icon 218 is used to simplify the drawing of interactions between process components.

Interactions between process component pairs involving their respective business objects, process agents, operations, interfaces, and messages are described as process component interactions, which determine the interactions of a pair of process components across a deployment unit boundary, i.e., from one deployment unit to another deployment unit. Interactions between process components are indicated in FIG. 1 by directed lines (arrows). Interactions between process components within a deployment unit need not be described except to note that they exist, as these interactions are not constrained by the architectural design and can be implemented in any convenient fashion. Interactions between process components that cross a deployment unit boundary will be illustrated by the figures of this patent application; these figures will show the relevant elements associated with potential interaction between two process components, but interfaces, process agents, and business objects that are not relevant to the potential interaction will not be shown.

The architectural design is a specification of a computer software application, and elements of the architectural design can be implemented to realize a software application that implements the end-to-end process mentioned earlier. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, which a typical business user would expect and understand with little explanation. Business objects are further categorized as business process objects and master data objects. A master data object is an object that encapsulates master data (i.e., data that is valid for a period of time). A business process object, which is the kind of business object generally found in a process component, is an object that encapsulates transactional data (i.e., data that is valid for a point in time). The term business object will be used generically to refer to a business process object and a master data object, unless the context requires otherwise. Properly implemented, business objects are implemented free of redundancies.

The architectural elements also include the process component. A process component is a software package that realizes a business process and generally exposes its functionality as services. The functionality contains business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters serving as a signature.

The architectural elements also include the service interface, referred to simply as the interface. An interface is a named group of operations. Each operation belongs to exactly one interface. An interface belongs to exactly one process component. A process component might contain multiple interfaces. In one implementation, an interface contains only inbound or outbound operations, but not a mixture of both. One interface can contain both synchronous and asynchronous operations. All operations of the same type (either inbound or outbound) which belong to the same message choreography will belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a create, update, or delete of a business object instance.

Synchronous outbound process agents are generally triggered directly by a business object.

An output process agent will generally perform some processing of the data of the business object instance whose change triggered the event. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction must be performed by the process components of one instance of one deployment unit.

The process components of one deployment unit interact with those of another deployment unit using messages passed through one or more data communication networks or other suitable communication channels. Thus, a deployment unit deployed on a platform belonging one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interaction within other deployment units. Similarly, process components that interact with other process components or external systems only through messages, e.g., as sent and received by operations, can also be replaced as long as the replacement supports the operations of the original.

Interactions between Process Components “Further Cash Management” and “Cash Management”

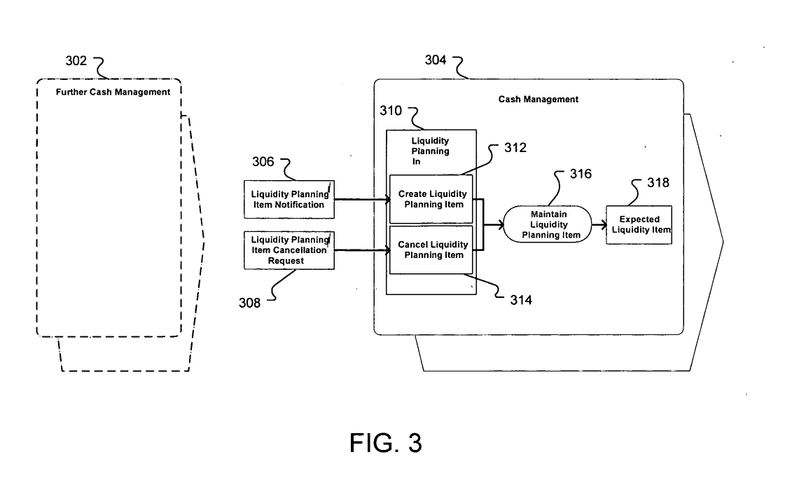

FIG. 3 is a block diagram showing interactions between a Further Cash Management process component 302 and a Cash Management process component 304 in the architectural design of FIG. 1. The Further Cash Management process component 302 may include an interface providing an operation that transmits a Liquidity Planning Item Notification message 306 and a Liquidity Planning Item Cancellation Request message 308. For example, the Liquidity Planning Item Notification message 306 may be a manual entry representing a financial status or future cash flow that includes a valid to date.

The Cash Management process component 304 provides a Liquidity Planning In interface 310. Here, the interface 310 includes a Create Liquidity Planning Item operation 312 and a Cancel Liquidity Planning Item operation 314. The Create Liquidity Planning Item operation 312 may be invoked upon receipt of a Liquidity Planning Item Notification message 306. Next, the Create Liquidity Planning Item operation 312 sends a request for the liquidity planning item notification to the Maintain Liquidity Planning Item inbound process agent 316. Alternatively, the Cancel Liquidity Planning Item operation 314 may be invoked upon receipt of a Liquidity Planning Item Cancellation Request message 308. Upon canceling the request, the Cancel Liquidity Planning Item operation 314 sends a request with the liquidity planning item cancellation request to the Maintain Liquidity Planning Item inbound process agent 316.

The Maintain Liquidity Planning Item inbound process agent 316 can maintain liquidity planning items within a liquidity plan document. For example, the Maintain Liquidity Planning Item inbound process agent 316 may receive a creation or a cancellation request from an operation contained the Liquidity Planning In interface 310. Here, the process agent 316 invokes an Expected Liquidity Planning Item business object 318 to update the liquidity plan document.

Interactions Between Process Components “Cash Management” and “Due Item Processing”

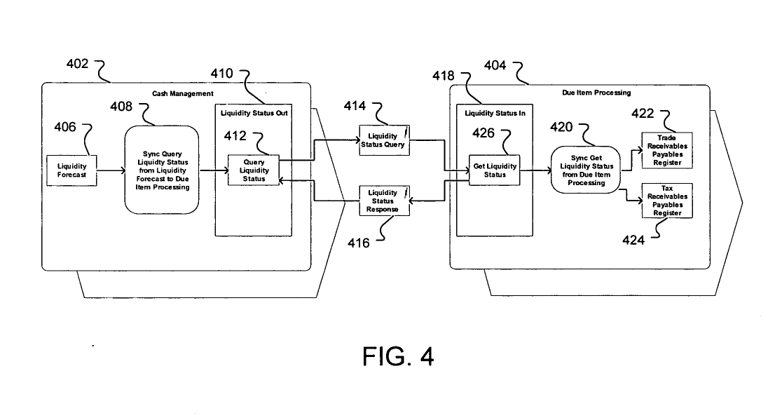

FIG. 4 is a block diagram showing interactions between a Cash Management process component 402 and a Due Item Processing process component 404 in the architectural design of FIG. 1. The Cash Management process component 402 contains a Liquidity Forecast business object 406, a Sync Query Liquidity Status from Liquidity Forecast to Due Item Processing outbound process agent 408, and a Liquidity Status Out interface 410.

The Liquidity Forecast business object 406 represents requests or instructions to the cash management department to post financial status or future cash flow information. The Liquidity Forecast business object 406 presents the financial status including future cash flows.

The Sync Query Liquidity Status from Liquidity Forecast to Due Item Processing outbound process agent 408 is invoked by the Liquidity Forecast business object 406 to provide liquidity forecast information. For example, the outbound process agent 408 may be requested to get liquidity status for trade and tax on receivables and payables. Here, the outbound process agent 408 invokes a synchronous Query Liquidity Status operation 412 provided by the Liquidity Status Out interface 410. Upon completion of the operation, the Query Liquidity Status operation 412 transmits a Liquidity Status Query message 414 requesting trade and tax status on receivables and payables. Similarly, the Query Liquidity Status operation 412 can receive a Liquidity Status Response message 416 that contains the result of the query.

The Due Item Processing process component 404 contains a Liquidity Status In interface 418, a Sync Get Liquidity Status from Due Item Processing inbound process agent 420, and two business objects: a Trade Receivables Payables Register business object 422 and a Tax Receivables Payables Register business object 424.

The Liquidity Status In interface 418 includes a synchronous Get Liquidity Status operation 426. Here, the operation 426 can receive the Liquidity Status Query message 414 requesting trade and tax status on receivables and payables. The Get Liquidity Status operation 426 sends a request to the Sync Get Liquidity Status from Due Item Processing inbound process agent 420. Upon completion of the request, the Get Liquidity Status operation 426 provides the result of the query in the Liquidity Status Response message 416 for use by the process component that originated the query. Here, to process the query, the process agent 420 invokes at least one included business object, such as a Trade Receivables Payables Register business object 422 or a Tax Receivables Payables Register business object 424. The Trade Receivables Payables Register business object 422 may represent all receivables and payables for goods and services traded by a company with its business partners. The Tax Receivables Payables Register business object may represent all tax due for the corresponding receivables and payables such as: delivered goods and rendered services between buyers and sellers, the consumption of goods, the transfer of goods, or vendor payments withheld. Upon completion of the Get Liquidity Status operation 426, a Liquidity Status Response message 416 is transmitted to the Cash Management process component 402. Here, the message 416 contains the result of the query.

Interactions Between Process Components “Payment Processing” and “Settlement Processing at Clearing House”

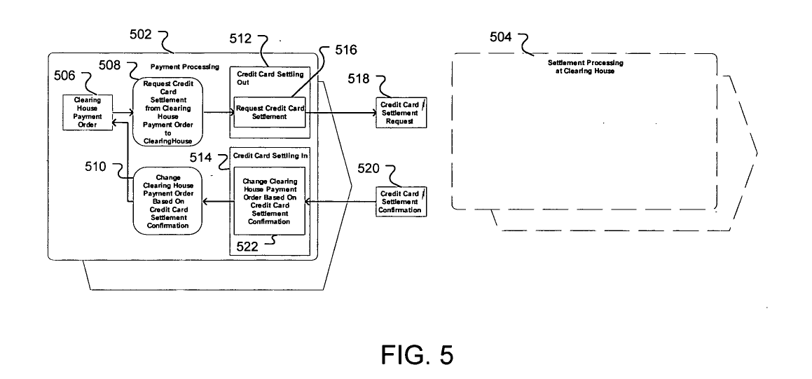

FIG. 5 is a block diagram showing interactions between a Payment Processing process component 502 and a Settlement Processing at Clearing House process component 504 in the architectural design of FIG. 1. The Payment Processing process component 502 is used to handle credit card payments and settlements. The Settlement Processing at Clearing House process component 504 is used to handle all incoming settlement requests from various process components, and to provide the corresponding settlement confirmations to the various requesting process components.

The Payment Processing process component 502 contains a Clearing House Payment Order business object 506, a Request Credit Card Settlement from Clearing House Payment Order to Clearing House outbound process agent 508, a Change Clearing House Payment Order Based on Credit Card Settlement Confirmation inbound process agent 510, and two interfaces: a Credit Card Settling Out interface 512 and a Credit Card Settling In interface 514.

The Clearing House Payment Order business object 506 represents orders for clearing a collection of credit card payments to the clearing house. The Clearing House Payment Order business object 506 initiates credit card settlements within the Payment Processing process component 502. The Clearing House Payment Order business object 506 first sends a request for a settlement to the Request Credit Card Settlement from Clearing House Payment Order to Clearing House outbound process agent 508. For example, the request may be to clear credit card payments to the clearing house. Here, the process agent 508 invokes a Request Credit Card Settlement operation 516 provided by the Credit Card Settling Out interface 512. Next, the Request Credit Card Settlement operation 516 transmits a Credit Card Settlement Request message 518 requesting the settlement be made.

The Settlement Processing at Clearing House process component 504 receives the Credit Card Settlement Request message 518 and performs the settlement. Upon completion of the settlement, the Settlement Processing at Clearing House process component 504 transmits a Credit Card Settlement Confirmation message 520.

The Credit Card Settlement Confirmation message 520 initiates the settlement confirmation within the Payment Processing process component 502. The Credit Card Settlement Confirmation message 520 is received by a Change Clearing House Payment Order Based on Credit Card Settlement Confirmation operation 522 provided by the Credit Card Settling In interface 514. Here, the operation 522 sends a request to the Change Clearing House Payment Order Based on Credit Card Settlement Confirmation inbound process agent 510. The inbound process agent 510 invokes the Clearing House Payment Order business object 506 to complete the operation. For example, the payment department is updated to show that the credit card settlements have occurred at the clearing house.

Interactions Between Process Components “Due Item Processing” and “Accounting”

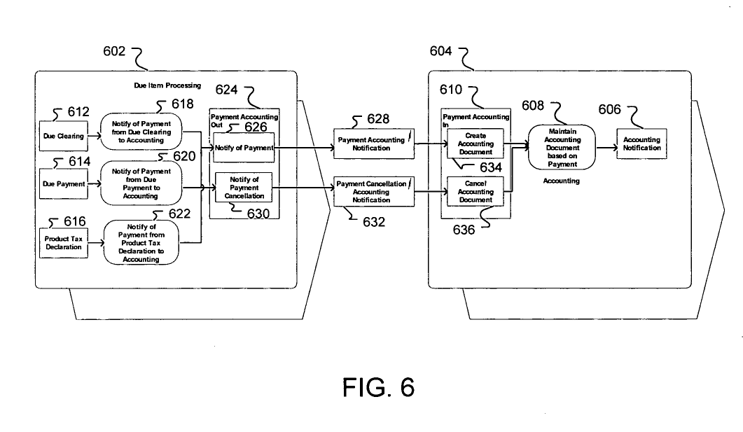

FIG. 6 is a block diagram showing interactions between a Due Item Processing process component 602 and an Accounting process component 604 in the architectural design of FIG. 1. The Accounting process component 604 contains an Accounting Notification business object 606, a Maintain Accounting Document based on Payment inbound process agent 608, and a Payment Accounting In interface 610. The Accounting Notification business object 606 represents a common input channel for recording some or all operational business transactions into financial accounting.

The Due Item Processing process component 602 contains three business objects, three outbound process agents, and one interface. The three business objects include: a Due Clearing business object 612, a Due Payment business object 614, and a Product Tax Declaration business object 616. The outbound process agents include: a Notify of Payment from Due Clearing to Accounting outbound process agent 618, a Notify of Payment from Due Payment to Accounting outbound process agent 620, and a Notify of Payment from Product Tax Declaration to Accounting outbound process agent 622. The interface is a Payment Accounting Out interface 624.

The Due Clearing business object 612 represents a group of receivables and payables for clearing. “Clearing” means that the amounts of the receivables and payables of a group balance to zero taking cash discounts and other deductions into account. The “group” is typically payments and invoices that belong together, but it can also be credit memos and invoices, or customer and vendor invoices. A group results uniquely from the invoice reference information of a payment.

The Due Payment business object 614 represents payment requests for payment processing. This can be done manually or automatically. In contrast to payment requests from Human Capital Management solution, or Treasury, Due Payment is responsible for the payment and clearing of payables and receivables from goods and services.

The Product Tax Declaration business object 616 represents the product tax liabilities/receivables of a company to the responsible tax authority according to the tax declaration arrangement and country specific legal requirements that triggers the payment to the tax authority.

Any of the three business objects 612, 614, 616 may initiate a payment notification. In one type of interaction, the Due Clearing business object 612 first sends a request for payment notification to the Notify of Payment from Due Clearing to Accounting outbound process agent 618. For example, the request may be to send notification for a clearing of trade receivables and/or payables to accounting. Here, the Notify of Payment from Due Clearing to Accounting outbound process agent 618 invokes a Notify of Payment operation 626 provided by the Payment Accounting Out interface 624. Upon completion of the operation, the Notify of Payment operation 626 transmits a Payment Accounting Notification message 628 requesting the accounting entry be made. In another type of interaction, the Due Payment business object 614 first sends a request for payment notification to the Notify of Payment from Due Payment to Accounting outbound process agent 620. In another type of interaction, the request may be to send notification to accounting for inward or outward trade receivables and/or payables payments. Here, the process agent 620 invokes the Notify of Payment operation 626 to transmit a Payment Accounting Notification message 628, requesting the accounting entry be made. In another type of interaction, the Product Tax Declaration business object 616 first sends a request for payment notification to the Notify of Payment from Product Tax Declaration to Accounting outbound process agent 622. For example, the request may be to send notification for a payment of tax receivables and/or payables to accounting. Here, the process agent 622 invokes a Notify of Payment operation 626 to transmit a Payment Accounting Notification message 628, requesting the accounting entry be made.

The Due Clearing business object 612 and the Accounting business object 614 may initiate a payment cancellation. In one type of interaction, the Due Clearing business object 612 first sends a request for payment cancellation to the Notify of Payment from Due Clearing to Accounting outbound process agent 618. For example, the request may be to send cancellation for a clearing of trade receivables and/or payables to accounting. Here, the Notify of Payment from Due Clearing to Accounting outbound process agent 618 invokes the Request Payment Cancellation operation 630 provided by the Payment Accounting Out interface 624. Upon completion of the operation, the Request Payment Cancellation operation 630 transmits the Payment Accounting Cancellation Request message 632 requesting the accounting entry be made. In another type of interaction, the Due Payment business object 614 first sends a request for payment cancellation to the Notify of Payment from Due Payment to Accounting outbound process agent 620. For example, the request may be to send cancellation to accounting for inward or outward trade receivables and/or payables payments. Here, the process agent invokes the Request Payment Cancellation operation 630 provided by the Payment Accounting Out interface 624. Upon completion of the operation, the Request Payment Cancellation operation 630 transmits a Payment Accounting Cancellation Request message 632 requesting the accounting entry be made.

The Payment Accounting Notification message 628 and the Payment Accounting Cancellation Request message 632 initiate payment accounting within the Accounting process component 604. For payment notifications, the Payment Accounting Notification message 628 is received by a Create Accounting Document operation 634 provided by the Payment Accounting In interface 610. Here, the operation 634 sends a request to the Maintain Accounting Document based on Payment inbound process agent 608, which updates the Accounting Notification business object 606. For example, the accounting documents are updated to show payment has been made. Similarly, for payment cancellations, the Payment Accounting Cancellation Request message 632 is received by a Cancel Accounting Document operation 636 provided by the Payment Accounting In interface 610. Here, the operation 636 sends a request to the Maintain Accounting Document based on Payment inbound process agent 608, which updates the Accounting Notification business object 606. For example, the accounting documents are updated to show payment has been cancelled.

Interactions Between Process Components “Payment Processing” and “Payment Order Processing at House Bank”

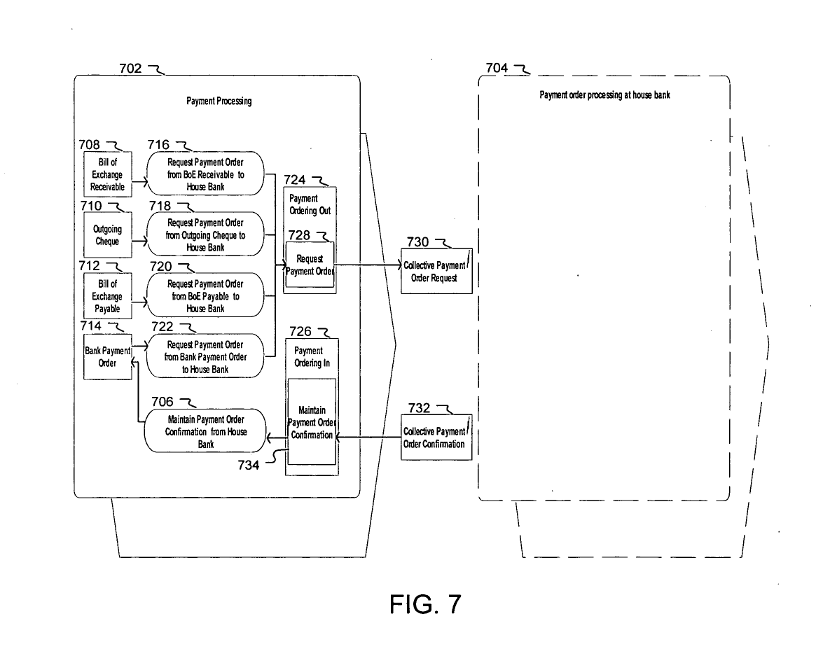

FIG. 7 is a block diagram showing interactions between a Payment Processing process component 702 and a Payment order processing at house bank process component 704 in the architectural design of FIG. 1. The Payment Processing process component 702 contains four business objects, four outbound process agents, a Maintain Payment Order Confirmation from House Bank inbound process agent 706, and two interfaces. The business objects include: a Bill of Exchange Receivable business object 708, an Outgoing Check business object 710, a Bill of Exchange Payable business object 712, and a Bank Payment Order business object 714. The outbound process agents include: a Request Payment Order from BoE Receivable to House Bank outbound process agent 716, a Request Payment Order from Outgoing Check to House Bank outbound process agent 718, a Request Payment Order from BoE Payable to House Bank outbound process agent 720, and a Request Payment Order from Bank Payment Order to House Bank outbound process agent 722. The interfaces include: a Payment Ordering Out interface 724 and a Payment Ordering In interface 726.

The Bill of Exchange Payable business object 708 represents a bill of exchange sent to a business partner. For example, it may be created only via a payment order. The Outgoing Check business object 710 represents a check sent to a business partner. For example, it may be created via payment order. The Bill of Exchange Payable business object 712 represents a bill of exchange received from, or sent to, a business partner. The Bank Payment Order business object 714 represents bank payment orders which are sent to a house bank. The bank payment orders may contain bank transfers as well direct debits.

Any of the four business objects 708, 710, 712, 714 may initiate processing within the Payment Processing process component 702. In one type of interaction, the Bill of Exchange Receivable business object 708 first sends a request for a payment order to the Request Payment Order from BoE Receivable to House Bank outbound process agent 716. For example, the request may be to create an electronic bill of exchange receivable. Here, the process agent 716 invokes a Request Payment Order operation 728 provided by the Payment Ordering Out interface 724. Upon completion of the operation, the Request Payment Order operation 728 transmits a Collective Payment Order Request message 730 requesting the electronic bill of exchange be created. In another type of interaction, the Outgoing Check business object 710 first sends a request for a check to the Request Payment Order from Outgoing Check to House Bank outbound process agent 718. For example, the request may be to create an outgoing check to be printed externally. Here, the process agent 718 invokes a Request Payment Order operation 728 provided by the Payment Ordering Out interface 724. Upon completion of the operation, the Request Payment Order operation 728 transmits a Collective Payment Order Request message 730 requesting the check be created. In yet another type of interaction, the Bill of Exchange Payable business object 712 first sends a request for a payment order to the Request Payment Order from BoE Payable to House Bank outbound process agent 720. For example, the request may be to create an electronic bill of exchange payable. Here, the process agent 720 invokes a Request Payment Order operation 728 provided by the Payment Ordering Out interface 724. Upon completion of the operation, the Request Payment Order operation 728 transmits a Collective Payment Order Request message 730 requesting the payment be made. In yet another type of interaction, the Bank Payment Order business object 714 first sends a request for a payment order to the Request Payment Order from BoE Payable to House Bank outbound process agent 722. For example, the request may be to create a payment order. Here, the process agent 722 invokes a Request Payment Order operation 728 provided by the Payment Ordering Out interface 724. Upon completion of the operation, the Request Payment Order operation 728 transmits a Collective Payment Order Request message 730 requesting the bank payment be made.

The Payment order processing at house bank process component 704 receives the Collective Payment Order Request message 730 and posts the payment. Upon completion of the payment posting, the Payment order processing at house bank process component 704 transmits a Collective Payment Order Confirmation message 732 back to the requesting process component.

The Collective Payment Order Confirmation message 732 initiates confirmation processing within the Payment Processing process component 702. The Collective Payment Order Confirmation message 732 is received by a Maintain Payment Order Confirmation operation 734 provided by the Payment Ordering In interface 726. Here, the operation 734 sends a request to the Maintain Payment Order Confirmation from House Bank inbound process agent 706. The process agent invokes the Bank Payment Order business object 714 to complete the operation. For example, the bank payment order is updated to show confirmation that a payment was made.

Interactions Between Process Components “Payment Processing” and “Accounting”

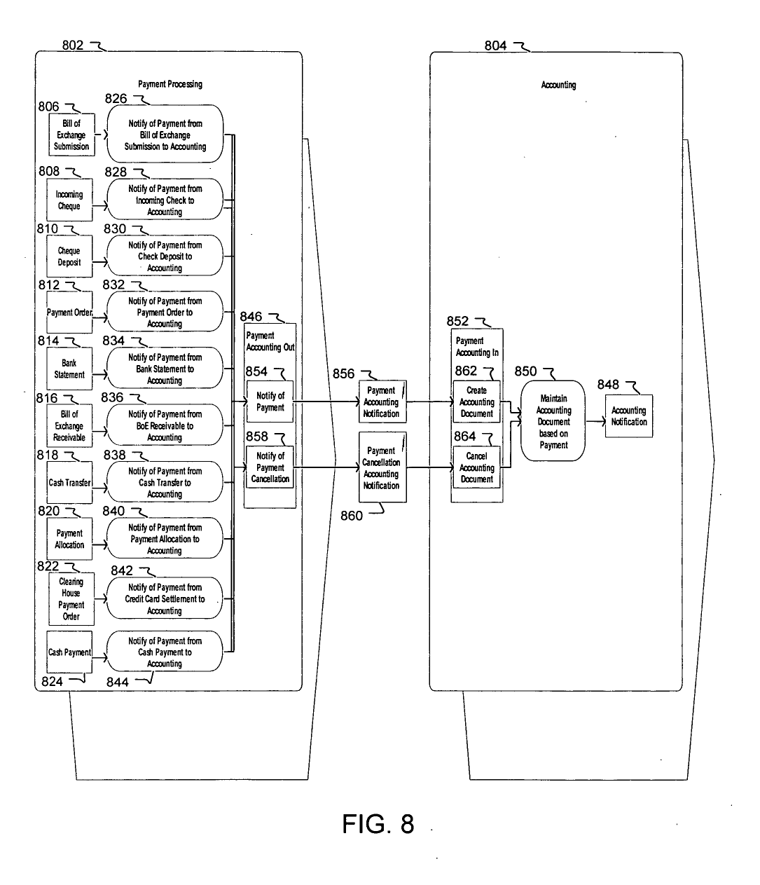

FIG. 8 is a block diagram showing interactions between a Payment Processing process component 802 and an Accounting process component 804 in the architectural design of FIG. 1. The Payment Processing process component 802 contains ten business objects, ten outbound process agents, and one interface. Any of the ten business objects may initiate payment notification or payment cancellations within the Payment Processing process component 802. The business objects include: a Bill of Exchange Submission business object 806, an Incoming Check business object 808, a Check Deposit business object 810, a Payment Order business object 812, a Bank Statement business object 814, a Bill of Exchange Receivable business object 816, a Cash Transfer business object 818, a Payment Allocation business object 820, a Clearing House Payment Order business object 822, and a Cash Payment business object 824. The outbound process agents include: a Notify of Payment from Bill of Exchange Submission to Accounting outbound process agent 826, a Notify of Payment from Incoming Check to Accounting outbound process agent 828, a Notify of Payment from Check Deposit to Accounting outbound process agent 830, a Notify of Payment from Payment Order to Accounting outbound process agent 832, a Notify of Payment from Bank Statement to Accounting outbound process agent 834, a Notify of Payment from BoE Receivable to Accounting outbound process agent 836, a Notify of Payment from Cash Transfer to Accounting outbound process agent 838, a Notify of Payment from Payment Allocation to Accounting outbound process agent 840, a Notify of Payment from Credit Card Settlement to Accounting outbound process agent 842, and a Notify of Payment from Cash Payment to Accounting outbound process agent 844. The interface is a Payment Accounting Out interface 846.

The Accounting process component 804 contains an Accounting Notification business object 848, a Maintain Accounting Document based on Payment inbound process agent 850, and a Payment Accounting In interface 852. The Accounting Notification business object 848 represents journal entries and other accounting entries made to reflect business transactions.

The Bill of Exchange Submission business object 806 represents a business operation of sending incoming bills of exchange to the house bank for cashing. The Incoming Check business object 808 represents a check sent by a business partner. The Check Deposit business object 810 represents a collection of incoming checks sent to the house bank for cashing. The Payment Order business object 812 represents payment media for another bank, institution or business partner. The Bank Statement business object 814 represents bank statements for house bank accounts. The Bill of Exchange Receivable business object 816 presents bills of exchange received from or sent to a business partner. The Cash Transfer business object 818 represents internal money transfers between banks. The Payment Allocation business object 820 represents how open payments of different type belonging to one another are indicated as confirmed or sent to other components for post processing. The Clearing House Payment Order business object 822 represents orders for clearing a collection of credit card payments to the clearing house. The Cash Payment business object 824 represents incoming or outgoing cash payments from or to a business partner.

Within the Payment Processing process component 802, payment notifications may be initiated. In one type of interaction, the Bill of Exchange Submission business object 806 first sends a request to the Notify of Payment from Bill of Exchange Submission to Accounting outbound process agent 826. For example, the request may be to notify accounting of a bill of exchange submission. Here, the outbound process agent 826 invokes a Notify of Payment operation 854 provided by the Payment Accounting Out interface 846. Upon completion of the operation, the Notify of Payment operation 854 transmits a Payment Accounting Notification message 856, requesting the accounting entry be made.

In another type of interaction, the Incoming Check business object 808 first sends a request to the Notify of Payment from Incoming Check to Accounting outbound process agent 828. For example, the request may be to notify accounting of relevant incoming checks. Here, the outbound process agent 828 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Check Deposit business object 810 first sends a request to the Notify of Payment from Check Deposit to Accounting outbound process agent 830. For example, the request may be to notify accounting that check deposits have been made. Here, the outbound process agent 830 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Payment Order business object 812 first sends a to the Notify of Payment from Payment Order to Accounting outbound process agent 832. For example, the request may be to notify financial accounting of a self-initiated payment. Here, the outbound process agent 832 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Bank Statement business object 814 first sends a request to the Notify of Payment from Bank Statement to Accounting outbound process agent 834. For example, the request may be to notify accounting of payments on bank accounts. Here, the outbound process agent 834 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Bill of Exchange Receivable business object 816 first sends a request to the Notify of Payment from BoE Receivable to Accounting outbound process agent 836. For example, the request may be to notify accounting of a BoE receivable payment. Here, the outbound process agent 836 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Cash Transfer business object 818 first sends a request to the Notify of Payment from Cash Transfer to Accounting outbound process agent 838. For example, the request may be to notify accounting of relevant transfers of money between house bank accounts and cash accounts. Here, the outbound process agent 838 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Payment Allocation business object 820 first sends a request to the Notify of Payment from Payment Allocation to Accounting outbound process agent 840. For example, the request may be to notify accounting of a new payment allocation. Here, the outbound process agent 840 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Clearing House Payment Order business object 822 first sends a request to the Notify of Payment from Credit Card Settlement to Accounting outbound process agent 842. For example, the request may be to notify accounting of the submission of credit card payments to the clearing house. Here, the outbound process agent 842 invokes the Notify of Payment operation 854 provided by the Payment Accounting Out interface 846. Upon completion of the operation, the Notify of Payment operation 854 transmits a Payment Accounting Notification message 856, requesting the accounting entry be made.

In yet another type of interaction, the Cash Payment business object 824 first sends a request to the Notify of Payment from Cash Payment to Accounting outbound process agent 844. For example, the request may be to notify accounting of relevant cash payments. Here, the outbound process agent 844 invokes the Notify of Payment operation 854 provided by the Payment Accounting Out interface 846. Upon completion of the operation, the Notify of Payment operation 854 transmits a Payment Accounting Notification message 856, requesting the accounting entry be made.

Similarly, within the Payment Processing process component 802, payment cancellations also may be initiated. In one type of interaction, the Bill of Exchange Submission business object 806 first sends a request to the Notify of Payment from Bill of Exchange Submission to Accounting outbound process agent 826. For example, the request may be to notify accounting of a bill of exchange cancellation. Here, the outbound process agent 826 invokes a Request Payment Cancellation operation 858 provided by the Payment Accounting Out interface 846. Upon completion of the operation, the Request Payment Cancellation operation 858 transmits a Payment Accounting Cancellation_Request message 860, requesting the accounting entry be made.

In another type of interaction, the Incoming Check business object 808 first sends a request to the Notify of Payment from Incoming Check to Accounting outbound process agent 828. For example, the request may be to notify accounting of relevant voided checks. Here, the outbound process agent 828 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Check Deposit business object 810 first sends a request to the Notify of Payment from Check Deposit to Accounting outbound process agent 830. For example, the request may be to notify accounting that check deposits have been reversed. Here, the outbound process agent 830 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Payment Order business object 812 first sends a to the Notify of Payment from Payment Order to Accounting outbound process agent 832. For example, the request may be to notify financial accounting of an self-initiated payment cancellation. Here, the outbound process agent 832 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Bank Statement business object 814 first sends a request to the Notify of Payment from Bank Statement to Accounting outbound process agent 834. For example, the request may be to notify accounting of payment cancellations on bank accounts. Here, the outbound process agent 834 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Bill of Exchange Receivable business object 816 first sends a request to the Notify of Payment from BoE Receivable to Accounting outbound process agent 836. For example, the request may be to notify accounting of a BoE receivable payment cancellation. Here, the outbound process agent 836 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Cash Transfer business object 818 first sends a request to the Notify of Payment from Cash Transfer to Accounting outbound process agent 838. For example, the request may be to notify accounting of relevant transfer cancellations of money between house bank accounts and cash accounts. Here, the outbound process agent 838 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Payment Allocation business object 820 first sends a request to the Notify of Payment from Payment Allocation to Accounting outbound process agent 840. For example, the request may be to notify accounting to cancel a payment allocation. Here, the outbound process agent 840 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Clearing House Payment Order business object 822 first sends a request to the Notify of Payment from Credit Card Settlement to Accounting outbound process agent 842. For example, the request may be to notify accounting of the reversal of credit card payments to the clearing house. Here, the outbound process agent 842 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

In yet another type of interaction, the Cash Payment business object 824 first sends a request to the Notify of Payment from Cash Payment to Accounting outbound process agent 844. For example, the request may be to notify accounting of relevant cash payment cancellations. Here, the outbound process agent 844 invokes the Request Payment Cancellation operation 858 provided by the Payment Accounting Out interface 846. Upon completion of the operation, the Request Payment Cancellation operation 858 transmits a Payment Accounting Cancellation Request message 860, requesting the accounting entry be made.

The Payment Accounting Notification message 856 or the Payment Accounting Cancellation Request message 860 initiate notifications or cancellations within the Accounting process component 804.

For payment notifications, the Payment Accounting Notification message 856 is received by a Create Accounting Document operation 862 provided by the Payment Accounting In interface 852. Here, the operation 862 sends a request to the Maintain Accounting Document based on Payment inbound process agent 864, which updates the Accounting Notification business object 848. For example, the accounting documents are updated to indicate that the payment has been made.

For payment cancellations, the Payment Accounting Cancellation Request message 860 is received by a Cancel Accounting Document operation 866 provided by the Payment Accounting In interface 852. Here, the operation 866 sends a request to the Maintain Accounting Document based on Payment inbound process agent 864, which updates the Accounting Notification business object 848. For example, the accounting documents are updated to indicate that the cancellation has occurred.

Interactions Between Process Components “Payment Processing” and “Due Item Processing”

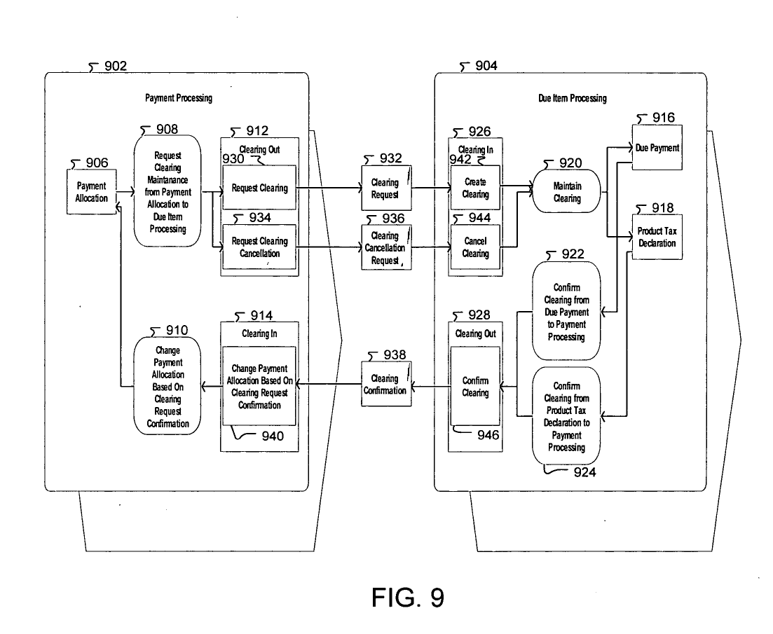

FIG. 9 is a block diagram showing interactions between a Payment Processing process component 902 and a Due Item Processing process component 904 in the architectural design of FIG. 1. The Payment Processing process component 902 contains a Payment Allocation business object 906, a Request Clearing Maintenance from Payment Allocation to Due Item Processing outbound process agent 908, a Change Payment Allocation Based On Clearing Request Confirmation inbound process agent 910, a Clearing Out interface 912, and a Clearing In interface 914.

The Payment Allocation business object 906 represents a process step by which open payments of different types belonging to one another are indicated as confirmed or sent to other components for post processing.

The Due Item Processing process component 904 contains a Due Payment business object 916, a Product Tax Declaration business object 918, a Maintain Clearing inbound process agent 920, a Confirm Clearing from Due Payment to Payment Processing outbound process agent 922, a Confirm Clearing from Product Tax Declaration to Payment Processing outbound process agent 924, a Clearing In interface 926, and a Clearing Out interface 928.

The Due Payment business object 916 represents payment requests for payment processing. The Product Tax Declaration business object 918 represents product tax liabilities/receivables of a company to a responsible tax authority.

The Payment Allocation business object 906 initiates clearing requests within the Payment Processing process component 902. The Payment Allocation business object 906 first sends a clearing request to the Request Clearing Maintenance from Payment Allocation to Due Item Processing outbound process agent 908. For example, the request may be to request clearing of payments. Here, the outbound process agent 908 invokes a Request Clearing operation 930 provided by the Clearing Out interface 912. Upon completion of the operation, the Request Clearing operation 930 transmits a Clearing Request message 932 requesting the clearing be made in due item processing. Similarly, the Payment Allocation business object 906 may first send a cancellation request to the Request Clearing Maintenance from Payment Allocation to Due Item Processing outbound process agent 908. For example, the request may be to cancel a previously-sent clearing request. Here, the outbound process agent 908 invokes a Request Clearing Cancellation operation 934 provided by the Clearing Out interface 912. Upon completion of the operation, the Request Clearing Cancellation operation 934 transmits a Clearing Cancellation Request message 936 requesting the previously-sent clearing be cancelled in due item processing.

The Clearing Confirmation message 938 initiates updates to payment allocations within the Payment Processing process component 902. The Clearing Confirmation message 938 is received by a Change Payment Allocation Based On Clearing Request Confirmation operation 940 provided by the Clearing In interface 914. Here, the operation 940 sends a request to the Change Payment Allocation Based On Clearing Request Confirmation inbound process agent 910, which updates the Payment Allocation business object 906. For example, the Payment Allocation documents are updated to show that the clearing request has been confirmed.

The Clearing Request message 932 and Clearing Cancellation Request message 936 can initiate processing within the Due Item Processing process component 904. The Clearing Request message 932 is received by a Create Clearing operation 942 provided by the Clearing In interface 926. Here, the operation 942 sends a request to the Maintain Clearing inbound process agent 920, which updates the Due Payment business object 916 and the Product Tax Declaration business object 918. For example, the payment documents and product tax declaration documents are updated based on the cleared payment. Similarly, the Clearing Cancellation Request message 936 initiates clearing cancellations within the Due Item Processing process component 904. The Clearing Cancellation Request message 936 is received by a Cancel Clearing operation 944 provided by the Clearing In interface 926. Here, the operation 944 sends a request to the Maintain Clearing inbound process agent 920, which updates the Due Payment business object 916 and the Product Tax Declaration business object 918. For example, the payment documents and product tax declaration documents are updated based on the clearing cancellation.

The Due Payment business object 916 or the Product Tax Declaration business object 918 may initiate clearing confirmations within the Due Item Processing process component 904. To confirm a due payment clearing, the Due Payment business object 916 first sends a request to the Confirm Clearing from Due Payment to Payment Processing outbound process agent 922, which invokes a Confirm Clearing operation 946 provided by the Clearing Out interface 928. Next, the Confirm Clearing operation 946 transmits a Clearing Confirmation message 938 confirming the transaction. For example, the message may confirm or reject clearing of a foreign-initiated payment for trade receivables payables. To confirm a product tax declaration clearing, the Due Payment business object 918 first sends a request to the Confirm Clearing from Product Tax Declaration to Payment Processing outbound process agent 924, which invokes the Confirm Clearing operation 946 provided by the Clearing Out interface 928. Next, the Confirm Clearing operation 946 transmits a Clearing Confirmation message 938 confirming the transaction. For example, the message may confirm or reject clearing of a foreign-initiated payment for tax receivables payables from product tax.

Interactions Between Process Components “Lockbox File Creation at Provider” and “Payment Processing”

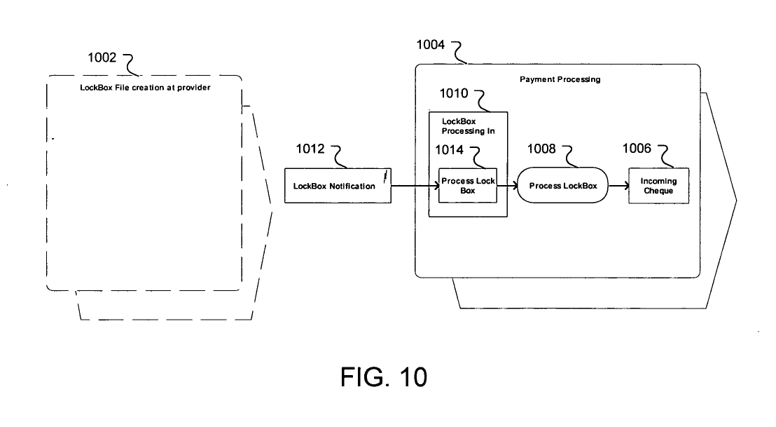

FIG. 10 is a block diagram showing interactions between a LockBox File creation at provider process component 1002 and a Payment Processing process component 1004 in the architectural design of FIG. 1. The Payment Processing process component 1004 contains an Incoming Check business object 1006, a Process LockBox inbound process agent 1008, and a LockBox Processing In interface 1010. The Incoming Check business object 1006 represents a check sent by a business partner. For example, the incoming check can be sent to the house bank by a check deposit.

The LockBox Notification message 1012 initiates processing within the Payment Processing process component 1004. The message may originate from the LockBox File creation at provider process component 1002 or another process component. The LockBox Notification message 1012 is received by a Process Lock Box operation 1014 provided by the LockBox Processing In interface 1010. Here, the operation 1014 sends a request to the Process LockBox inbound process agent 1008, which updates the Incoming Check business object 1006. For example, the check register documents are updated to include the lockbox contents.

Interactions Between Process Components “Bank Statement Creation at Bank” and “Payment Processing”

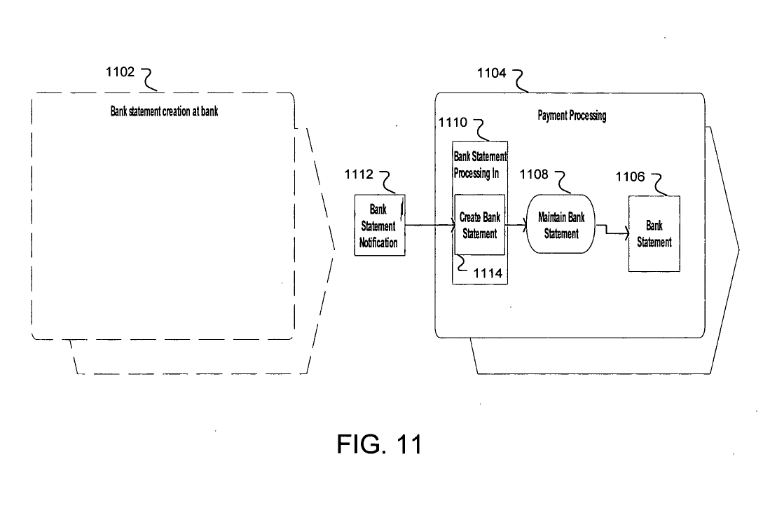

FIG. 11 is a block diagram showing interactions between a Bank statement creation at bank process component 1102 and a Payment Processing process component 1104 in the architectural design of FIG. 1. The Payment Processing process component 1104 contains a Bank Statement business object 1106, a Maintain Bank Statement inbound process agent 1108, and a Bank Statement Processing In interface 1110. The Bank Statement business object 1106 represents a bank statement for a house bank account.

The Bank Statement Notification message 1112 initiates bank statement updates within the Payment Processing process component 1104. The message 1112 may originate from the Bank statement creation at bank process component 1102 or another process component. The Bank Statement Notification message 1112 is received by a Create Bank Statement operation 1114 provided by the Bank Statement Processing In interface 1110. Here, the operation 1114 sends a request to the Maintain Bank Statement inbound process agent 1108, which updates the Bank Statement business object 1106. For example, the bank statement documents are updated to reflect the payment.

The subject matter described in this specification and all of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back end component (e.g., a data server), a middleware component (e.g., an application server), or a front end component (e.g., a client computer having a graphical user interface or a Web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as an exemplification of preferred embodiments of the invention. Certain features that are described in this specification in the context of separate embodiments, may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer program product comprising application software encoded on a tangible machine-readable information carrier, the application software being structured as process components interacting with each other through service interfaces, the software comprising:
a plurality of process components, each of the process components being a package of software implementing a respective and distinct business process, the plurality of process components including:
an Accounting process component that records relevant business transactions;
a Due Item Processing process component that manages payables and receivables from service and supply;
a Payment Processing process component that handles incoming and outgoing payments as well as represent the main database for a liquidity status; and
a Cash Management process component that analyzes and manages the actual and future flow of money; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Cash Management process component and the Due Item Processing process component;
the Due Item Processing process component and the Accounting process component;
the Payment Processing process component and the Accounting process component; and
the Payment Processing process component and the Due Item Processing process component.

2. The product of claim 1, wherein:
each of the plurality of process components is assigned to exactly one deployment unit among multiple deployment units, and each deployment unit is deployable on a separate computer hardware platform independent of every other deployment unit; and
all interaction between a process component in one deployment unit and any other process component in any other deployment unit takes place through the respective service interfaces of the two process components.

3. The product of claim 2, wherein the deployment units comprise:
a Financial Accounting deployment unit that includes the Accounting process component;
a Due Item Management deployment unit includes the Due Item Management process component; and
a Payment deployment unit includes the Payment Processing process component and the Cash Management process component.

4. The product of claim 1, wherein:
each of the process components includes one or more business objects; and
none of the business objects of any one of the process components interacts directly with any of the business objects included in any of the other process components.

5. The product of claim 4, wherein the business objects comprise a business process object.

6. The product of claim 4, wherein:
none of the business objects included in any one of the process components is included in any of the other process components.

7. The product of claim 1, further comprising:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

8. The product of claim 7, wherein:
the inbound process agents comprise a first inbound process agent operable to start the execution of step requested in a first inbound message by creating or updating one or more business object instances.

9. The product of claim 7, wherein:
the outbound process agents comprise a first asynchronous outbound process agent that is called after a business object that is associated with the first outbound process agent changes.

10. The product of claim 1, wherein the operations comprise synchronous and asynchronous operations.

11. A system, comprising:
a computer system comprising one or more hardware platforms for executing a computer software application;
a plurality of process components, each of the process components being a package of software implementing a respective and distinct business process, the plurality of process components including:
an Accounting process component that records relevant business transactions;
a Due Item Processing process component that manages payables and receivables from service and supply;
a Payment Processing process component that handles incoming and outgoing payments as well as represent the main database for a liquidity status; and
a Cash Management process component that analyzes and manages the actual and future flow of money; and
a plurality of service interface operations, each service interface operation being implemented for a respective process component, the operations comprising inbound and outbound operations, the outbound operation for a first process component being operable to send a message to a second process component of the plurality of process components, the second process component having an inbound operation for receiving the message, the passing of messages between an inbound and an outbound operation defining a message-based pair-wise interaction between the respective process components of the respective operations, the pair-wise interactions between pairs of the process components including interactions between:
the Cash Management process component and the Due Item Processing process component;
the Due Item Processing process component and the Accounting process component;
the Payment Processing process component and the Accounting process component; and
the Payment Processing process component and the Due Item Processing process component.

12. The system of claim 11, wherein:
each of the process components includes one or more business objects; and
none of the business objects of any one of the process components interacts directly with any of the business objects included in any of the other process components.

13. The system of claim 11, wherein:
none of the business objects included in any one of the process components is included in any of the other process components.

14. The system of claim 11, wherein:
a plurality of process agents, each process agent being either an inbound process agent or an outbound process agent, an inbound process agent being operable to receive a message from an inbound operation, an outbound process agent being operable to cause an outbound operation to send a message, each process agent being associated with exactly one process component.

15. The system of claim 11, the system comprising multiple hardware platforms, wherein:
the Accounting process component is deployed on a first hardware platform;
the Due Item Management process component is deployed on a second hardware platform; and
the Payment Processing process component and the Cash Management process component are deployed on a third hardware platform.

16. The system of claim 15, wherein each of the first through the third hardware platforms are distinct and separate from each other.

17. A method for developing a computer software application, comprising:
obtaining in a computer system digital data representing an architectural design for a set of processes implementing an end-to-end application process, the design specifying a process component for each process in the set of processes, the design specifying further specifying a set of process component interactions, wherein
the specified process components include
an Accounting process component that records relevant business transactions;
a Due Item Processing process component that manages payables and receivables from service and supply;
a Payment Processing process component that handles incoming and outgoing payments as well as represent the main database for a liquidity status; and
a Cash Management process component that analyzes and manages the actual and future flow of money; and wherein
the process component interactions include interactions between
the Cash Management process component and the Due Item Processing process component;
the Due Item Processing process component and the Accounting process component;
the Payment Processing process component and the Accounting process component; and
the Payment Processing process component and the Due Item Processing process component; and
using the design including the specified process components and the specified process component interactions to develop a computer software application to perform the set of processes.

18. The method of claim 17, wherein:
each process in the set of processes is a business process transforming a defined business input into a defined business outcome.

19. The method of claim 18, wherein:
obtaining digital data representing the architectural design further comprises editing the design before using the design.
